(19) United States
(12) Patent Application Publication
(10) Pub. No.: US 2019/0016377 A1
(43) Pub. Date: Jan. 17, 2019

(54) STEERING CONTROL DEVICE

(71) Applicant: Hitachi Automotive Systems, Ltd., Hitachinaka-shi, Ibaraki (JP)

(72) Inventors: Tadashi SATOU, Tokyo (JP); Mitsuo SASAKI, Hitachinaka-shi (JP)

(73) Assignee: Hitachi Automotive Systems, Ltd., Hitachinaka-shi, Ibaraki (JP)

(21) Appl. No.: 16/069,257

(22) PCT Filed: Jan. 5, 2017
(86) PCT No.: PCT/JP2017/000098

§ 371 Date: Jul. 11, 2018

(30) Foreign Application Priority Data
Jan. 25, 2016 (JP) 2016-011198

(51) Int. Cl. B62D 5/04; B60Q 9/00; H02P 25/22; H02P 29/024; H02P 29/032

(52) U.S. Cl. CPC B62D 5/0481; B62D 5/0463; B60Q 9/00; H02P 27/06; H02P 29/024; H02P 29/032; H02P 25/22

(57) ABSTRACT

In a steering control device equipped with an electric motor having a plurality of winding sets and a plurality of assist current output sections each outputting a motor drive current caused to flow through each of the plurality of winding sets, it is possible to quickly make the driver aware of a state in which abnormality is generated and to suppress deterioration in operability in the state in which the abnormality has been generated.

The steering control device of the present invention includes: an electric motor 10 having a plurality of winding sets 11 and 12 and generating an assist torque for assisting steering wheel operation by a driver; a plurality of assist current output sections 51 and 52 each outputting a motor drive current to be caused to flow through each of the winding sets 11 and 12 in order to drive the electric motor 10; and an evaluation level determination section 60 detecting an abnormal condition relating to the plurality of winding sets 11 and 12 and the plurality of assist current output sections 51 and 52 and determining an evaluation level of the abnormal condition on the basis of the abnormal condition, and a magnitude of the assist torque generated by the electric motor 10 is varied based on the evaluation level.

### TECHNICAL FIELD

The present invention relates to a steering control device equipped with a motor drive section for imparting a steering force to a steering mechanism that steers steering wheels of a vehicle, a motor control section, and an electric motor formed by a winding set.

### BACKGROUND ART

As a steering control device assist-controlling steering wheel operation by a driver, there is known one equipped with an electric motor drive device as disclosed in JP-2012-025374-A (Patent Document 1). The electric motor drive device of Patent Document 1 is equipped with two inverters and two winding sets and is composed of two systems (See the Abstract). In this electric motor drive device, in the case where failure of an inverter (motor drive section) or a winding set of one of the two systems is detected, the power relay of the failure system is cut off, and the power supply to the failure system is stopped. On the other hand, the maximum current limited value that is the upper limit value of the current supply limited value of the normal system is set to a value equivalent to the maximum current limited value prior to the detection of the failure, and the power supply to the normal system is continued. After this, when the vehicle speed detection value is less than a predetermined threshold value, the maximum current limited value of the normal system is set to zero to stop the driving of the electric motor, creating a state in which no steering assist torque is generated. As a result, the electric motor drive device of Patent Document 1 can reliably make the driver aware of the generation of the failure.

### PRIOR ART DOCUMENT

Patent Document
Patent Document 1: JP-2012-25374-A

### SUMMARY OF THE INVENTION

### Problem to be Solved by the Invention

In the electric motor drive device of Patent Document 1, in the case where one system is out of order, the assist-control of the steering wheel is continued by the other, normal system. In the case where the vehicle speed detection value is less than a predetermined threshold value, the driving of the electric motor by the normal system is stopped, and there is created a state in which no steering assist torque is generated.

Thus, in the electric motor drive device of Patent Document 1, when the vehicle speed detection value is less than a predetermined threshold value and the steering assist torque is zero, the driver has to operate a rather heavy steering wheel, resulting in marked deterioration in the operability of the vehicle. In particular, during low speed traveling, the requisite steering torque is large, so that more assist torque by the electric motor is required than during high speed traveling. Thus, there arises a problem that the operability of the vehicle undergoes marked deterioration when the assist torque is reduced to zero at the time of turning to the right or left at low speed or during garaging.

It is an object of the present invention to provide a steering control device equipped with an electric motor having a plurality of winding sets and a plurality of assist current output sections each outputting a motor drive current caused to flow through each of the plurality of winding sets, thereby quickly making the driver aware of a state in which abnormality is generated and suppressing deterioration in operability in the state in which the abnormality has been generated.

### Means for Solving the Problem

To achieve the above object, there is provided in accordance with the present invention a steering control device including: an electric motor having a plurality of winding sets and generating an assist torque for assisting steering wheel operation by a driver; a plurality of assist current output sections each outputting a motor drive current to be caused to flow through each of the winding sets in order to drive the electric motor; and an evaluation level determination section detecting an abnormal condition relating to the plurality of winding sets and the plurality of assist current output sections and determining an evaluation level of the abnormal condition on the basis of the abnormal condition, and a magnitude of the assist torque generated by the electric motor is varied based on the evaluation level.

### Effect of the Invention

In accordance with the present invention, the magnitude of the assist torque generated by the electric motor is varied based on the evaluation level, whereby it is possible to quickly make the driver aware of the state in which abnormality is generated and to suppress deterioration in operability in the state in which the abnormality has been generated. As a result, it is possible to achieve an improvement in terms of the safety of the vehicle in a state in which abnormality has been generated in the steering control device. Other constructions, operations, and effects of the present invention will be described in detail in connection with the following embodiments.

### BRIEF DESCRIPTION OF THE DRAWINGS

FIG. 1 is a schematic diagram illustrating a construction of a steering control device according to a first embodiment of the present invention.

FIG. 2 is a control block diagram illustrating the steering control device of the first embodiment of the present invention.

FIG. 3 is an example of assist maps for the steering control device of the first embodiment of the present invention.

FIG. 4 is a flowchart according to the first embodiment of the present invention.

FIG. 5 is a danger level calculation flowchart according to the first embodiment of the present invention.

FIG. 6 is an example of the assist maps for the steering control device of the first embodiment of the present invention.

FIG. 7 is an example of the assist maps for the steering control device of the first embodiment of the present invention.

FIG. 8 is a danger level calculation flowchart according to a third embodiment of the present invention.

FIG. 9 is a diagram schematically illustrating a construction of a vehicle according to a fourth embodiment of the present invention which is equipped with a steering control device according to one of the first through third embodiments.

### MODES FOR CARRYING OUT THE INVENTION

In the following, embodiments of the present invention applied to a steering control device for assisting steering wheel operation in an automobile or the like will be described with reference to the drawings.

### Embodiment 1

In the following, a construction of the steering control device according to the first embodiment will be described.

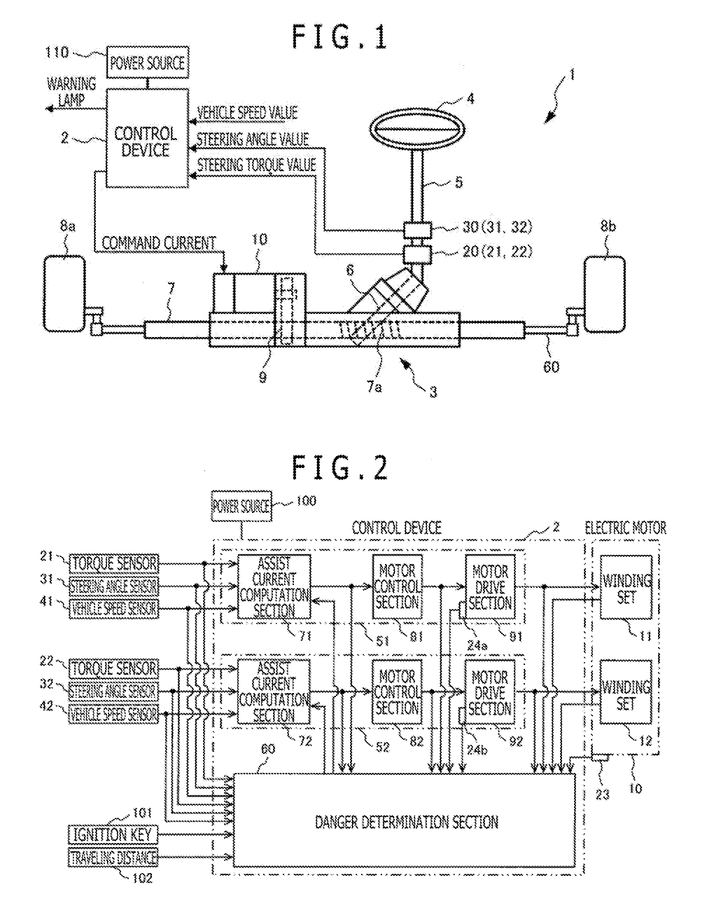

FIG. 1 is a diagram schematically illustrating the construction of the steering control device of the first embodiment of the present invention.

A steering control device 1 is equipped with a control device 2 and a steering mechanism 3. The steering mechanism 3 has a steering wheel 4, a steering shaft 5, a pinion shaft 6, a rack shaft 7, a speed reduction mechanism 9, and an electric motor 10, and the electric motor 10 is connected to the rack shaft 7 via a speed reduction mechanism 8. In this steering mechanism 3, when the steering wheel 4 is operated by the driver, rotation is transmitted to the pinion shaft 6 via the steering shaft 5. The rotational movement of the pinion shaft 6 is converted to a linear movement of the rack shaft 7, and left and right steered wheels 8a and 8b connected to both ends of the rack shaft 7 are steered. The rack shaft 7 has rack teeth 7a in mesh with the pinion shaft 8, and the rotational movement of the pinion shaft 6 is converted to a linear movement by the rack-and-pinion mechanism.

Further, between the steering shaft 5 and the pinion shaft 6, there are provided a torque sensor 20 (21, 22) and a steering angle sensor 30 (31, 32). The torque sensor 20 arranges a torsion bar (not shown) at the connection portion between the steering shaft 5 and the pinion shaft 6, and outputs a steering torque based on the angle of torsion of the torsion bar. For example, in FIG. 1, the speed reduction mechanism 9 connected to the electric motor 10 employs a ball screw driven by a belt/pulley mounted to the output shaft of the motor. Due to this construction, the drive torque of the electric motor 10 is converted to a translatory force of the rack shaft 7. The speed reduction mechanism 9 may adopt a construction using a rack and pinion like the input of the steering wheel 4 or a construction in which a nut of a ball screw is directly driven by a hollow motor or the like.

FIG. 2 is a control block diagram of the steering control device of the first embodiment of the present invention. FIG. 2 schematically illustrates the construction of the control device 2 formed by two systems and that of the electric motor 10.

Here, the term “system” refers to the combination unit of a motor control section 81 or 82, a motor drive section 91 or 92, and an assist current computation section 71 or 72 corresponding to one of two winding sets 11 and 12 provided inside the electric motor 10. While the control device 2 shown here is composed of two systems, the number of systems may be more than two.

In the present embodiment, the system composed of the winding set 11, the motor control section 81, the motor drive section 91, and the assist current computation section 71 will be referred to as the first system, and the system composed of the winding set 12, the motor control section 82, the motor drive section 92, and the assist current computation section 72 will be referred to as the second system. While in the present embodiment the torque sensor 20, the steering angle sensor 30, and a vehicle speed sensor 40 have separate sensors in the first and second systems, it is also possible to provide sensors common to the first and second systems.

The control device 2 is formed integrally with the electric motor 10 and has the function of storing and executing various control processing operations, and performs drive control of the electric motor 10 imparting the steering assist torque to the steering mechanism 3 on the basis of the control information of the torque sensor 20, the steering angle sensor 30, the vehicle speed sensor 40 (41, 42), etc. The specific control and construction of the control device 2 will be described in detail below.

The control device 2 is formed by assist current command sections 51 and 52 and a danger determination section (evaluation level determination section) 60. The assist current command sections 51 and 52 compute a drive current driving the electric motor 10 on the basis of the steering torque value detected by the torque sensor 20, the vehicle speed value detected by the vehicle speed sensor 40 installed, for example, in a differential gear (not shown), and outputs the drive current thus computed to the electric motor 10 side. The danger determination section 60 detects abnormality in the torque sensor value, or the like, and controls the assist current command sections 51 and 52.

The assist current command sections 51 and 52 are composed of the assist current computation sections 71 and 72, the motor control sections 81 and 82, and the motor drive sections 91 and 92, respectively, and each constitute an assist current output section outputting a motor drive current for driving the electric motor 10 to the corresponding wiring sets 11 and 12. The assist current computation sections 71 and 72 each compute a motor command current (current command value) drive-controlling the electric motor 10 on the basis of the steering torque value detected by the corresponding torque sensors 21 and 22 and the vehicle speed value detected by the corresponding vehicle speed sensors 41 and 42. The motor control sections 81 and 82 each generate a motor drive signal for the electric motor 10 on the basis of the motor command current. The motor drive sections 91 and 92 are each equipped with a device (inverter) converting the electric power of a DC power source to an AC power source, and each supply a motor drive current to the electric motor 10 in accordance with a motor drive signal.

The danger determination section 60 can detect abnormality of each signal from the output signals of the assist current computation sections 71 and 72, the output signals of the motor control sections 81 and 82, the output signals of the motor drive sections 91 and 92, the signals of the winding sets 11 and 12 of the electric motor 10, the signal of the torque sensor value of the torque sensor 20, the signal of the steering angle sensor value of the steering angle sensor 30, and the signal of the vehicle speed value of the vehicle speed sensor 40. That is, each signal includes abnormality information (abnormality signal) indicating the abnormal condition of the unit or sensor outputting that signal, and the danger determination section 60 inputs therein the abnormality information of each unit or sensor from each signal, detecting abnormality of each unit or sensor. Further, the danger determination section 60 determines the danger level (evaluation level) from each abnormality signal, and transmits a signal to the assist current computation sections 71 and 72 on the basis of the determination.

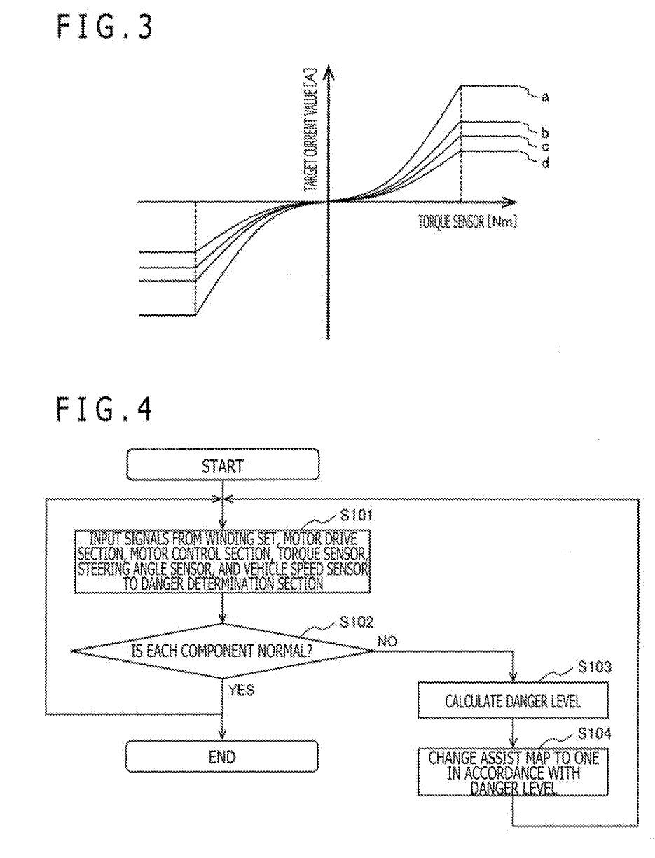

FIG. 3 is assist maps for obtaining a target current value to be supplied to the electric motor 10, computed by the assist current computation sections 71 and 72. The assist maps are reference maps to be referred to for the purpose of setting the target current value supplied to the electric motor 10 on the basis of the vehicle speed value and the torque sensor value, and are stored in the memory of each of the assist current computation sections 71 and 72. Using the assist maps, the assist current computation sections 71 and 72 each compute the target current value, that is, the current command value to be imparted to the respective motor control sections 81 and 82.

As shown in FIG. 3, in the assist maps, the relationship with the target current value is set such that the assist torque value due to the electric motor 10 increases as the torque sensor value increases. In FIG. 3, each of the assist maps is shown with respect to each of four vehicle speeds indicated by symbols a, b, c, and d. The relationship between the torque sensor value and the target current value is set for each vehicle speed. The lower the vehicle speed, the larger the target current value with respect to the torque sensor value. In FIG. 3, the vehicle speed is decreased in the order: d, c, b, and a. An upper limit value is set to the target current value. The target current value at a predetermined torque sensor value or more is set to a fixed level for each of the vehicle speeds a, b, c, and d. In FIG. 3, the predetermined torque sensor value leading to a fixed target current value is the same torque sensor value at each of the vehicle speeds a, b, c, and d.

In the above construction, a danger level is calculated by the danger determination section 60. The flowchart of FIG. 4 shows the computation processing by the danger determination section 60.

Taken into the danger determination section 60 are the signals from the winding sets 11 and 12, the motor control sections 81 and 82, the motor drive sections 91 and 92, the torque sensors 21 and 22, the steering angle sensors 31 and 32, and the vehicle speed sensors 41 and 42 (step S101). From the signals taken in, it is determined whether or not each component is normal (step S102). When all the components are normal, the procedure returns to start. When an abnormal condition is detected, the danger level is calculated (step S103), and the assist map is changed to one in accordance with the danger level (step S104). After the change of the assist maps, the procedure returns to start, and the monitoring of an abnormal condition is further continued.

The danger determination section (evaluation level determination section) 60 is a processing section calculating the danger level (evaluation level). It may also be called the danger level calculation section (evaluation level calculation section) or the danger level determination section (evaluation level determination section).

Next, the danger level calculation method will be described with reference to the flowchart of FIG. 5.

A coefficient kp is calculated from all the failure components and the specified abnormality cause or abnormality portion (step S201). The danger level is set by the abnormality cause or abnormality portion. The harder to recover the abnormality cause or abnormality portion, the higher the value of the coefficient kp as in the case of disconnection of the copper lines of the winding sets 11 and 12 and burning of a transistor in the motor drive sections 91 and 92.

Next, the coefficient ks is calculated from the presence/absence of a substitute of the component in the abnormal condition (step S202). Here, when a substitute exists, the danger level is low, and the coefficient ks is set to a small value. On the other hand, when there is no substitute, the danger level is high, and the coefficient ks is set to a large value.

Apart from varying the danger level in accordance with the presence/absence of a substitute, the coefficient ks raises the danger level when executing backup control by using the substitute as compared with the case where usual control is executed. Examples of the backup control include the backup control executed by using a substitute torque sensor signal when the torque sensor 20 is out of order. In the case where this backup control is executed, the danger level determination section 60 determines that the danger level has been raised.

Next, a lapse determination coefficient kc is calculated (step S203). The lapse determination coefficient kc is a coefficient used to determine the increase in danger level after component failure. Examples of the lapse coefficient kc include the passage of time after it has been determined that there is a component in an abnormal condition and the number of times that the ignition has been turned on and off. As the passage of time or the number of time that the ignition has been turned on and off increases, the value of the coefficient kc increases.

From the product of the above coefficients kp, ks, and kc, a synthetic danger level is calculated (step S204). In the case where a plurality of abnormal conditions have been generated, the danger level is calculated for each component, and the sum total thereof is the danger level value.

In accordance with this danger level value, the changing of the assist map is conducted in step S104 of FIG. 4. In this case, the assist map is changed in accordance with the increase in the danger level determined by the danger determination section 60, whereby the assist torque generated by the electric motor 10 is reduced. The assist map is selected such that in accordance with the increase in danger level determined by the danger determination section 60, the upper limit value of the target current value (current command value) is reduced.

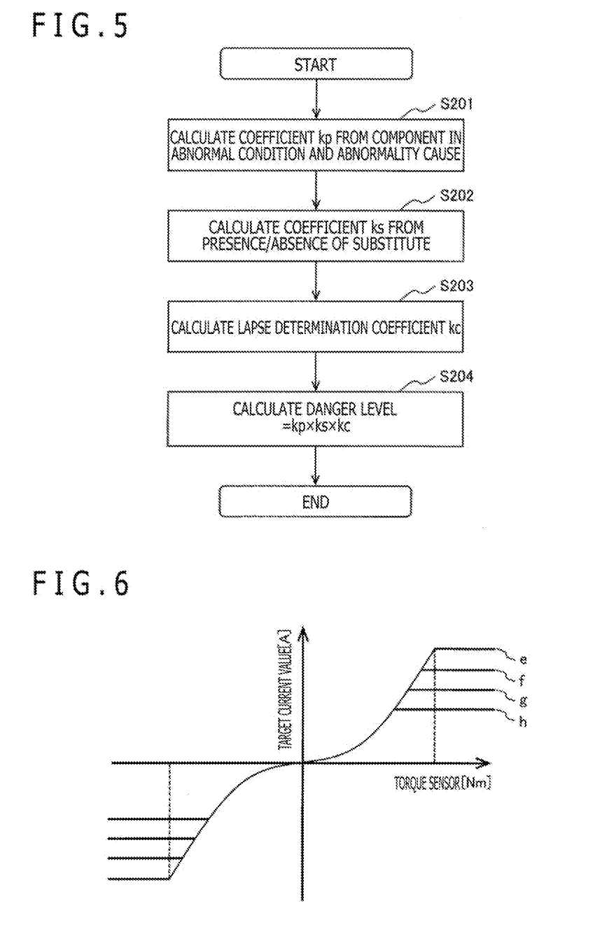

FIG. 6 shows an example of the assist maps for the steering control device according to the first embodiment of the present invention. In the example of the assist maps shown in FIG. 6, the motor current value supplied to the electric motor 10 is obtained in accordance with the danger level.

As described above, in the assist maps, the target current value supplied to the electric motor 10 is set for each vehicle speed value with respect to the torque sensor value. That is, in the assist maps, the relationship between the torque sensor value and the target current value to be supplied to the electric motor 10 is set. In FIG. 6, with respect to one characteristic curve indicating the relationship between the torque sensor value and the target current value, there are shown a plurality of assist maps e, f, g, and h the upper limit values of which are set to a plurality of levels. The torque sensor value leading to the upper limit value is diminished in the order: e, f, g, and h. The assist map e attains the upper limit value with the maximum torque sensor value, whereas the assist map h attains the upper limit value with the minimum torque sensor value.

In the case where the danger level as determined by the danger determination section 60 is zero, that is, in the case where all the components are free from abnormal condition, the target current value is calculated from the curve the upper limit value of which is e. In the case where the danger level has been increased, the target current value with respect to the torque sensor value is calculated by using the curve in which the upper limit value of the target current value is reduced in the order: f, g, and h as the danger level increases.

Even in a state in which abnormality has been generated in one of the components, the assist torque during high-speed traveling in which the torque sensor value is low and in which the requisite steering torque for the driver is low, the same curve e as that in the normal condition is employed. In this way, the assist torque is not reduced during high-speed traveling and in a traveling condition in which the danger level is high, i.e., in a condition in which the damage at the time of accident is great, the assist torque is not reduced. In the first place, the requisite steering torque during traveling is low, so that it is difficult to make the driver aware of the abnormal condition through a reduction in assist torque. Thus, safety is secured by conducting the same assist control as that for the normal condition. During low-speed traveling in which the torque sensor value increases, there is employed an assist map in which the target current value has been reduced through an increase in danger level (the curve f, g, or h). Thus, the requisite steering torque for the driver increases, and he can be easily made aware of the abnormal condition. Further, due to the low-speed traveling, even if abnormality is generated in all the normal substitute components, and the assist force due to the electric motor 10 is completely lost, the tire reaction force is small, so that the driver can cope with the situation to prevent an unstable vehicle traveling.

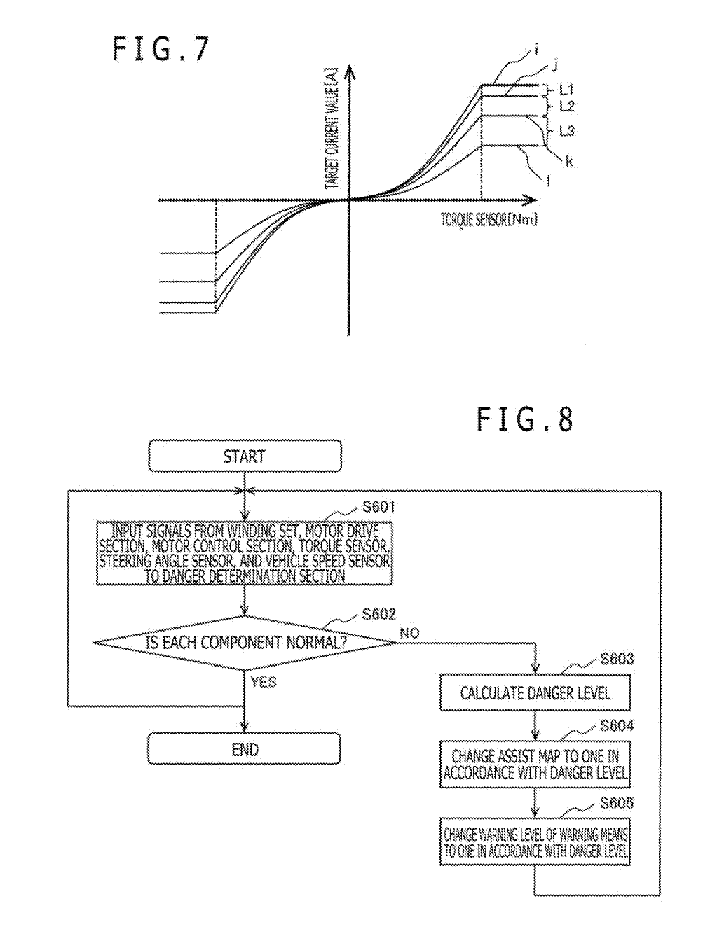

FIG. 7 shows another example of the assist maps for the steering control device according to the first embodiment of the present invention. In the example of FIG. 7, the reduction width of the assist map due to the increase in danger level by the danger determination section 60 is varied.

The assist maps consist of curves i, j, k, and 1 obtained by compressing, according to the increase in danger level, a curve of the target current value that is to be supplied to the electric motor 10 and that is corresponding to a torque sensor value, at a fixed ratio in the axial direction of the target current value. At this time, the reduction width of the upper limit value of the assist map with respect to the rise in danger level gradually increases as indicated by L1, L2, and L3. As a result, when the danger level is low, the reduction width of the assist torque is small, and the increase in the steering torque required of the driver is small, so that the driver experiences little incongruity in operability. Thus, while the vehicle is brought to the dealer or the like for repair, a high level is maintained in terms of operability and safety.

By reducing the assist torque as the danger level increases, the steering torque required of the driver increases, so that a reduction in operability is involved. It is, however, advantageously easier to make the driver aware of the failure condition, or to urge the driver already aware of the failure condition to have the vehicle repaired.

When the vehicle speed is zero or the ignition key is off, i.e., in a condition in which safety is secured, the assist torque is reduced to zero.

The term danger level refers to a condition in which the possibility of component failure has been increased in the controlling by the driver, and to a condition in which the possibility of the safety in vehicle traveling being lost has been increased due to the failure of the component. In determining the danger level, there is also taken into consideration of the magnitude of the damage to be expected in accordance with the driving condition such as the vehicle speed at that time.

In the present embodiment, the method of calculating the lapse determination coefficient kc in step S203 of the flowchart of FIG. 5 can be changed as follows.

The lapse determination coefficient kc is a coefficient used in determining the rise in the danger level after component failure. In the above description, it is the period of time that has elapsed after it is determined that there is a component in an abnormal condition or the number of times that the ignition key has been turned on/off. The value of the coefficient kc increases as the period of time that has elapsed or the number of times that the ignition key has been turned on/off increases.

In contrast, the value of the lapse determination coefficient kc may be calculated from the accumulative supply amount of current supplied to the winding sets 11 and 12 of the electric motor 10 or from the increase in the accumulative supply time. In this case, the lapse determination coefficient kc increases due to the increase in the accumulative current supply amount or the increase in the accumulative current supply time.

Alternatively, the lapse determination coefficient kc may be calculated from the traveling distance of the vehicle. In this case, the lapse determination coefficient kc increases in accordance with the increase in the traveling distance of the vehicle.

Alternatively, the lapse determination coefficient kc may be calculated from the accumulative number of times that the steering wheel has been operated or the number of times that the steering wheel has been turned quickly. In this case, the lapse determination coefficient kc increases in accordance with the increase in the accumulative number of times that the steering wheel has been operated, the accumulative number of rotation, or the number of times that the steering wheel has been turned quickly.

Apart from the above-mentioned coefficients kp, ks, and kc, the electric motor 10 and the motor drive sections 91 and 92 may be respectively provided with temperature sensors 23, 24a, and 24b (See FIG. 2), and the danger determination section 60 may determine the danger level based on the temperature history detected by the temperature sensors 23, 24a, and 24b.

### Embodiment 2

The second embodiment of the present invention will be described with reference to FIG. 8.

The present embodiment differs from the first embodiment solely in the computation processing by the danger determination section 60. In the present embodiment, the basic structure of the steering control device 1 and the construction of the control device 2 are the same as those of the first embodiment, so a description thereof will be left out.

The computation processing by the danger determination section 60 will be described with reference to the flowchart of FIG. 8. FIG. 8 is a flowchart for the danger level calculation according to the third embodiment of the present invention.

The danger determination section 60 takes in the signals from the winding sets 11 and 12, the motor control sections 81 and 82, the motor drive sections 91 and 92, the torque sensors 21 and 22, the steering angle sensors 31 and 32, and the vehicle speed sensors 41 and 42 (step S601). From the signals taken in, it is determined whether or not each component is normal (step S602). When all the components are normal, the procedure returns to start. In the case where an abnormal condition is detected, the danger level is calculated (step S603), and the assist map is changed to one in accordance with the danger level (step S604). Further, in accordance with the danger level, a warning level of a warning device (warning means) is changed (step S605). After the changing of the warning level, the procedure returns to start, and the monitoring of an abnormal condition is further continued.

By changing the warning level (warning amount) of the warning device, deterioration in the vehicle controllability due to the warning is suppressed.

The warning device is a device informing the driver of an abnormal condition. For example, the sound of a buzzer can be employed as the warning device. An increase in the warning level is reported to the driver through a change in volume, sound pressure, and frequency. As another example of the warning device, an indicator lamp may be lighted, or vibration may be imparted to the steering wheel, or the engine start performance may be changed by the ignition key.

### Embodiment 3

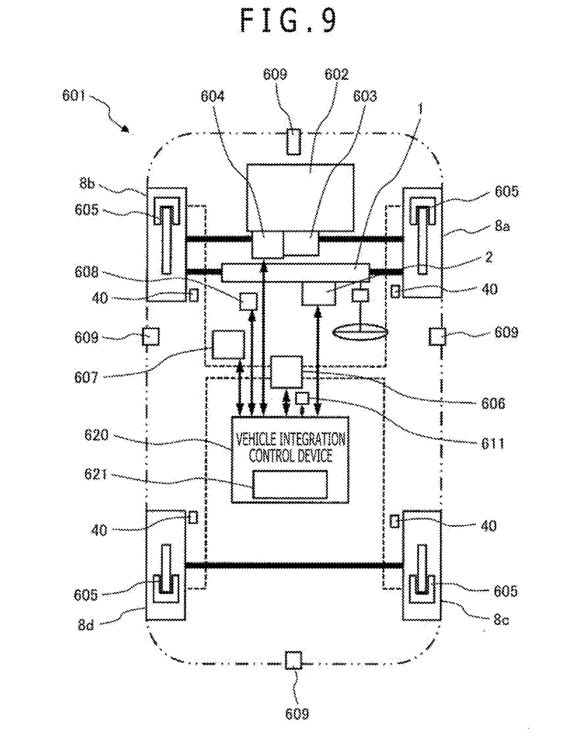

The third embodiment of the present invention will be described with reference to FIG. 9. The present embodiment will be described in connection with a vehicle equipped with a steering control device. The steering control device the vehicle is equipped with may be either steering control device 1 described in connection with the first embodiment or the second embodiment.

FIG. 12 is a diagram schematically illustrating a vehicle 601 equipped with the steering control device 1 according to the present invention.

This vehicle 601 is equipped with an engine 602 as the power source. The power source is not restricted to an engine. It may also be an electric motor used singly, or a combination of an electric motor and an engine. The rotation of the engine 602 drives steered wheels 8a and 8b via a speed reduction gear 603. While the present embodiment will be described as applied to a structure using the front wheels 8a and 8b as the driving wheels and the rear wheels 8c and 8d as driven wheels, this should not be construed restrictively.

Apart from the above components, the vehicle 601 is equipped with the steering control device 1, the control device 2, a brake device 605, a brake device control device 606, an in-vehicle map information presentation device 607, a GPS 608, a sensor 609 including at least one of a camera, a sonar, and a laser radar, a sensor 611 including a longitudinal acceleration sensor, a lateral acceleration sensor, and a yaw rate sensor, and the vehicle speed sensors 41 and 42.

Further, the vehicle 601 is equipped with a vehicle integration control device 620 that performs integrated control through the input of the condition (signal) of the above-mentioned devices mounted in the vehicle 601, an actuator, a sensor, and apparatuses, and transmission/reception of signals can be performed through an in-vehicle LAN such as a CAN.

In the present embodiment, the device condition is input to the vehicle integration control device 602 from the engine control device 604, the brake control device 606, the control device 2 of the steering control device 1, etc. Inside the vehicle integration control device 602, there is provided a danger determination section 621, to which there is sent information on malfunction of each control device and failure information. Based on this failure information, the vehicle danger level is determined, and information on the vehicle danger level is output to the control device 2. Thus, also in the case where failure of the vehicle 601 other than an abnormal condition of the electric motor 10 of the steering control device 1 is detected, the danger level increases, and the assist torque is reduced in accordance with the danger level. Alternatively, the warning level of the warning device is changed.

Input to the vehicle integration control device 602 are the signals from the in-vehicle map information presentation device 607, the GPS 608, and the sensor 609 such as a camera, sonar, or laser radar. Thus, it is possible to obtain information on the vehicle position, the vehicle traveling condition, and the vehicle periphery from the above signals. Based on the information, the danger level is determined by the danger determination section 621, and information on the danger level is output to the control device 2 of the steering control device 1. Thus, the danger determination section 621 synthetically determines the information on the vehicle position, the vehicle traveling condition, and the vehicle periphery, and changes the danger level.

Suppose that, for example, the danger level has increased due to failure of the plurality of motor drive sections 91 of the steering control device 1, and that the assist torque has been reduced. In the case where it is determined in this condition that the steering torque due to the driver is large from the information on the vehicle periphery obtained from the GPS 608 and the sensor 609 such as a camera, sonar, or laser radar, the danger level is reduced, and the assist torque due to the electric motor is increased. As a result, the steering torque required of the driver is reduced, resulting in an improvement in terms of steering property.

As described above, the vehicle integration control device 620 is provided with the danger determination section 621, whereby it is possible to synthetically determine the failure condition of each device in the vehicle 601, the vehicle traveling condition, and the vehicle periphery condition to calculate the danger level.

According to the embodiments of the present invention described above, the magnitude of the assist torque generated by the electric motor 10 is changed based on the danger level, whereby it is possible to quickly make the driver aware of the state in which abnormality is generated, and to suppress deterioration in operability in the state in which the abnormality has been generated. As a result, it is possible to achieve an improvement in terms of the vehicle safety in the state in which abnormality has been generated in the steering control device 1. Thus, in the above-described embodiments, a plurality of assist maps shown in FIGS. 3, 6, and 7 are changed in accordance with the increase in the danger level determined by the danger determination section 60, whereby the assist torque generated by the electric motor 10 is reduced. Alternatively, the plurality of assist maps are set such that the upper limit value of the current command value computed by the assist current computation sections 71 and 72 is reduced in accordance with the increase in the danger level determined by the danger determination section 60. Alternatively, the plurality of assist maps are set such that the current command value computed by the assist current computation sections 71 and 72 is gradually reduced in accordance with the increase in the danger level determined by the danger determination section 60.

The present invention is not restricted to the embodiments described above but includes various modifications. For example, while the above embodiment have been described in detail to facilitate the understanding of the present invention, the present invention is not always restricted to a construction equipped with all the components mentioned above. Further, a part of a certain embodiment may be replaced by the construction of another embodiment. Further, the construction of another embodiment may be added to the construction of a certain embodiment. Further, addition, deletion, and replacement of another construction are possible with respect to a part of the construction of each embodiment.

### DESCRIPTION OF REFERENCE CHARACTERS

1 . . . Steering control device, 2 . . . Steering mechanism, 3 . . . Control device, 4 . . . Steering wheel, 5 . . . Steering shaft, 6 . . . Pinion shaft, 7 . . . Rack shaft, 8a, 8b . . . Steered wheel, 9 . . . Speed reduction mechanism, 10 . . . Electric motor, 20, 21, 22 . . . Torque sensor, 30, 31, 32 . . . Steering angle sensor, 40, 41, 42 . . . Vehicle speed sensor, 51, 52 . . . Assist current command section, 60 . . . Danger determination means, 71, 72 . . . Assist current computation section, 81, 82 . . . Motor control section, 91, 92 . . . Motor drive section, 101 . . . Ignition key, 102 . . . Traveling distance

1. A steering control device comprising:
an electric motor having a plurality of winding sets and generating an assist torque for assisting steering wheel operation by a driver;
a plurality of assist current output sections each outputting a motor drive current to be caused to flow through each of the winding sets in order to drive the electric motor; and
an evaluation level determination section detecting an abnormal condition relating to the plurality of winding sets and the plurality of assist current output sections and determining an evaluation level of the abnormal condition on the basis of the abnormal condition,
wherein a magnitude of the assist torque generated by the electric motor is varied based on the evaluation level.

2. The steering control device according to claim 1, wherein
each of the assist current output sections includes:
an assist current computation section computing a current command value;
a motor control section generating a motor drive signal based on the current command value; and
a motor drive section outputting a motor drive current to each of the winding sets on the basis of the motor drive signal; and
the assist current computation section calculates an assist torque generated by the electric motor on the basis of a steering torque value detected by a torque sensor and the evaluation level determined by the evaluation level determination section.

3. The steering control device according to claim 2, wherein:
the evaluation level determination section determines danger level as the evaluation level;
the assist current computation section is provided with a plurality of assist maps used to calculate the current command value corresponding to an assist torque generated by the electric motor on the basis of the steering torque value and a vehicle speed detected by a vehicle speed sensor; and
in accordance with an increase in the evaluation level determined by the evaluation level determination section, a change is performed on the assist maps, whereby an assist torque generated by the electric motor is reduced.

4. The steering control device according to claim 2, wherein:
the evaluation level determination section determines danger level as the evaluation level;
the assist current computation section is provided with a plurality of assist maps used to calculate the current command value corresponding to an assist torque generated by the electric motor on the basis of the steering torque value and a vehicle speed detected by a vehicle speed sensor; and
the plurality of assist maps are set such that an upper limit value of the current command value is reduced in accordance with an increase in evaluation level determined by the evaluation level determination section.

5. The steering control device according to claim 2, wherein:
the evaluation level determination section determines danger level as the evaluation level;
the assist current computation section is provided with a plurality of assist maps used to calculate the current command value corresponding to an assist torque generated by the electric motor on the basis of the steering torque value and a vehicle speed detected by a vehicle speed sensor; and
the plurality of assist maps are set such that the current command value is gradually reduced in accordance with an increase in evaluation level determined by the evaluation level determination section.

6. The steering control device according to claim 2, wherein:
the evaluation level determination section determines danger level as the evaluation level;
the assist current computation section is provided with a plurality of assist maps used to calculate the current command value corresponding to an assist torque generated by the electric motor on the basis of the steering torque value and a vehicle speed detected by a vehicle speed sensor; and
the plurality of assist maps are set such that a reduction width of the current command value is changed in accordance with evaluation level determined by the evaluation level determination section.

7. The steering control device according to claim 6, wherein
the reduction width of the current command value in the assist maps increases in accordance with an increase in evaluation level determined by the evaluation level determination section.

8. The steering control device according to claim 2, wherein
in a case where a command value from a vehicle sensor is zero or where an ignition key is off, the assist current output section sets the current command value to zero.

9. The steering control device according to claim 2, wherein:
the evaluation level determination section determines danger level as the evaluation level; and
the evaluation level determination section determines an increase in danger level from abnormality in the motor drive section, the motor control section, the winding sets, the steering torque value, and a vehicle speed value detected a vehicle speed sensor.

10. The steering control device according to claim 9, wherein
the evaluation level determination section determines that the danger level has been increased from an increase in a period of time that has elapsed since it is determined by the evaluation level determination section that there is danger or from an increase in a number of times that an ignition key has been turned on and off.

11. The steering control device according to claim 9, wherein
the evaluation level determination section determines that danger level has been increased with an increase in an accumulative current amount supplied to one of the winding sets from the motor drive section and with an increase in an accumulative power supply time since it is determined by the evaluation level determination section that there is danger.

12. The steering control device according to claim 9, wherein
the evaluation level determination section determines that there is an increase in danger level with an increase in a traveling distance of a vehicle since it is determined by the evaluation level determination section that there is danger.

13. The steering control device according to claim 9, wherein
the evaluation level determination section determines that there is an increase in danger level from a number of times that a steering wheel has been operated and from an accumulative number of rotation since it is determined by the evaluation level determination section that there is danger.

14. The steering control device according to claim 2, wherein:
the evaluation level determination section determines danger level as the evaluation level; and
the evaluation level determination section determines that there is an increase in danger level in a case where the torque sensor is out of order and backup control is executed by a substitute torque sensor signal.

15. The steering control device according to claim 2, wherein:
the electric motor and the motor drive section are each equipped with a temperature sensor; and
the evaluation level determination section determines evaluation level based on temperature history detected by the temperature sensor.

16. The steering control device according to claim 2, wherein:
the evaluation level determination section determines danger level as the evaluation level; and
the evaluation level determination section varies danger level in accordance with an abnormality cause or an abnormality portion.

17. The steering control device according to claim 16, wherein
in a determination of danger level by the evaluation level determination section, abnormality in one of the motor drive section and the winding sets is determined to be of higher danger level than abnormality in the torque sensor.

18. The steering control device according to claim 2, wherein
the evaluation level determination section determines danger level as the evaluation level, and determines the danger level in accordance with presence/absence and number of backup at the abnormality portion.

19. The steering control device according to claim 2, wherein
the evaluation level determination section determines danger level as the evaluation level, and executes warning by a warning device when it is determined that there is danger.

20. The steering control device according to claim 19, wherein
the evaluation level determination section changes warning level and a warning method by the warning device in accordance with the danger level.
